(19) United States
(12) Patent Application Publication
(10) Pub. No.: US 2007/0001622 A1
(43) Pub. Date: Jan. 4, 2007

(54) Balance transformer

(76) Inventors: Chun-Kong Chan, Hsi Chih City (TW); Jeng-Shong Wang, Hsin Chuang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/168,514

(22) Filed: Jun. 29, 2005

(51) Int. Cl. H05B 41/24

(52) U.S. Cl. 315/282

(57) ABSTRACT

The balance transformer with an auxiliary winding connecting to two CCFLs comprises a magnetic core that acts as a path for magnetic flux. The magnetic core is wound with a first coil, a second coil and an auxiliary coil. The winding direction of the first coil and the second coil are opposite. When the currents passing through the coils are balanced, there is no reaction voltage at the two ends of the auxiliary coil. When the currents of CCFLs are imbalanced or abnormal, the auxiliary coil produces a reaction voltage to act as a feedback signal for protecting the CCFLs.

### BACKGROUND OF THE INVENTION

1. Field of the Invention

The present invention relates to a balance transformer with an auxiliary winding. In particular, a transformer is used in a driving circuit of a cold cathode fluorescent lamp (CCFL).

2. Description of the Related Art

Cold cathode fluorescent lamps (CCFLs) have been used as a light source for the backlight module of LCD panels for a long time. A CCFL is driven by a driving circuit, such as an inverter. Due to technological improvements and the requirements of consumers, the size of LCD panels is becoming larger. For a large size LCD panel, a single CCFL cannot provide enough light source and two or more than two CCFLs are necessary. In order to maintain the uniformity of brightness of an LCD panel, the current of each CCFL needs to be adjustable at any time and makes the currents of each CCFL equal to each other. Because CCFLs are highly unstable and have negative resistance, it is difficult to make the resistance of each CCFL equal. As such, the current of each CCFL is unequal due to the change in the resistance of each CCFL. This makes the brightness of an LCD panel imbalanced and the aging rate of each CCFL is different; a CCFL having a larger current will be damaged and wear out more quickly.

The most common method to make each CCFL have the same brightness is to adopt an individual driving circuit and feedback controller for each CCFL. The current of all CCFLS is controlled at a fixed value via a common control signal. FIG. 1 shows a schematic diagram of a circuit adopting an individual driving circuit to drive each CCFL of the prior art. Taking two CCFLs as an example, the CCFLs 11, 12 are each driven and controlled by circuits 13, 14 and transformers 15, 16. The current I₁₁, I₁₂ of the CCFLs 11, 12 individually feedback to the circuits 13, 14 and are controlled by a pre-determined value to make the currents of each CCFL equal. However, each CCFL there needs a driving control circuit and these circuits have elements that are both costly and large in size.

An alternative method uses a single driving control circuit with a ballast element to make the difference between the current of each CCFL as small as possible. FIG. 2 shows a schematic diagram of a circuit adopting a single driving circuit to drive the CCFLs of the prior art. Taking two CCFLs as an example, two CCFLs 21, 22 connect together in parallel and are driven by a circuit 23 and a transformer 25. The high voltage ends of the CCFLs individually connect to capacitors 27, 28 to act as ballast elements. The resistance of the two capacitors 27, 28 is same and is larger than the resistance of the two CCFLs 21, 22. As such, the currents I₂₁, I₂₂ of the CCFLs 21, 22 are dominated by the resistance of the capacitors. Even though there is some difference between the CCFLs 21, 22, the variation of the currents I₂₁, I₂₂ is small and can be ignored. In this way, the currents of the CCFLs 21, 22 that are driven by a common high voltage driving circuit can be adjusted to a similar value. However, in order to control the current more precisely (the difference of the current I₂₁, I₂₂ is as small as possible), the circuit needs ballast elements with high resistance and must be operated with high driving voltage. The production of and procedures required for the high driving voltage are both costly and difficult, so this method has not been adopted by many producers.

FIG. 3 shows a schematic diagram of a circuit adopting differential current chokes to balance the driving current of the CCFLs of the prior art. When the currents I₃₁, I₃₂ are the same, the currents that flow through the first coil 302 and the second coil 304 are also the same. The magnetomotive force (MMF) of the first coil 302 produced by I₃₁ and the magnetomotive force (MMF) of the second coil 304 produced by I₃₂ are the same and cancel each other out. As such, there is no magnetic flux in the differential current choke 30. The leakage magnetic fluxes Φ1, Φ2 produced in the differential current choke 30 each form a loop via the outside air gap and the inductance effect produced by the loops can be ignored due to the fact that the magnetic resistance in the air gap is high.

When the current 131 of the first CCFL L1 and the current I₃₂ of the second CCFL L2 are different, the MMF of the first coil 302 produced by I₁₃ and the MMF of the second coil 304 produced by I₃₂ are also different. As such, the MMF in the differential current choke 30 is unequal and the difference between the MMF of the first coil 302 and the MMF of the second coil 304 will produce a mass of magnetic flux Φ in the differential current choke 30. The magnetic flux Φ slices the first coil 302 and the second coil 304 and reacts to produce an amended voltage ΔV. The amended voltage ΔV causes the current I₃₁ of the first CCFL L1 and the current I₃₂ of the second CCFL L2 to balance.

When we use the differential current choke 30 to balance the current of the CCFLs, an additional protection circuit 31 is still needed to protect the CCFLs under conditions in which the current running through the coils is imbalanced and is sensed by a voltage sensor 32. The differential current choke 30 feedbacks the currents flowed through the coils to a controller 33 to stabilize the current 131 of the first CCFL L1 and the current 132 of the second CCFL L2. The protection circuit 31 connects to the two coils of the differential current choke 30 and is composed of a plurality of electronic components (such as Q1, Q2, Q3 etc.) to sense whether the current of differential current choke 30 is within a predetermined value. If the current is extremely imbalanced, the protection circuit 31 issues a cut off signal to the controller 33 to protect the CCFLs when the current of the CCFLs is abnormal. The additional protection circuit 31 uses three transistors Q1, Q2 and Q3 to act as switches for protecting the CCFLs. However, the quantity and the cost of the electronic components of the protection circuit 31 are high. Furthermore, a lot of time and manpower are needed to assemble the protection circuit 31.

### SUMMARY OF THE INVENTION

The present invention provides a multi-CCFL balance transformer with an auxiliary winding to detect the imbalance or abnormal conditions of the current of the CCFLs and transmit a signal to a controller to protect the CCFLs. The balance transformer with an auxiliary winding comprises a magnetic core that can be a path of magnetic flux. The magnetic core is wound with a first coil, a second coil and an auxiliary coil. The winding direction of the first coil and the second coil are opposite to each other. When the currents passing through the coils are balanced, there is no reaction voltage at the two ends of the auxiliary coil. When the currents of the coils are imbalanced or abnormal, the auxiliary coil produces a reaction voltage that acts as a feedback signal for protecting the CCFLs.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a schematic diagram of a circuit adopting an individual driving circuit to drive each CCFL of the prior art;

FIG. 2 is a schematic diagram of a circuit adopting a single driving circuit to drive the CCFLs of the prior art;

FIG. 3 is a schematic diagram of a circuit adopting a differential current choke to balance the driving current of the CCFLs of the prior art;

FIG. 4 is a schematic diagram of an operating principle of a balance transformer with an auxiliary winding of the present invention; and

FIG. 5 is a schematic diagram of a circuit adopting the balance transformer with an auxiliary winding of the present invention to balance the currents of the CCFLs.

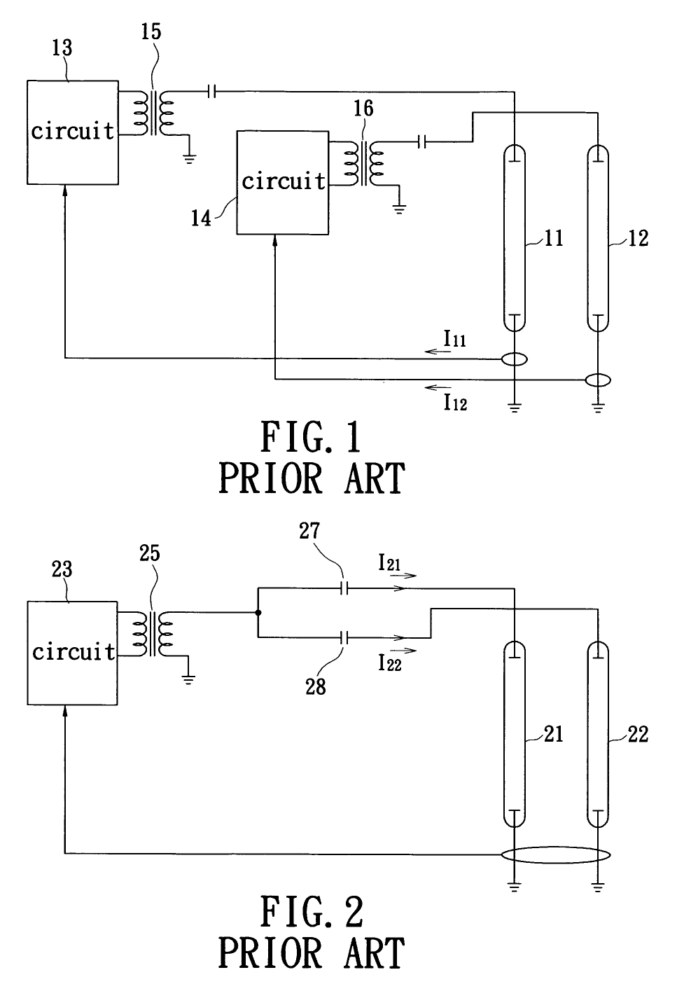

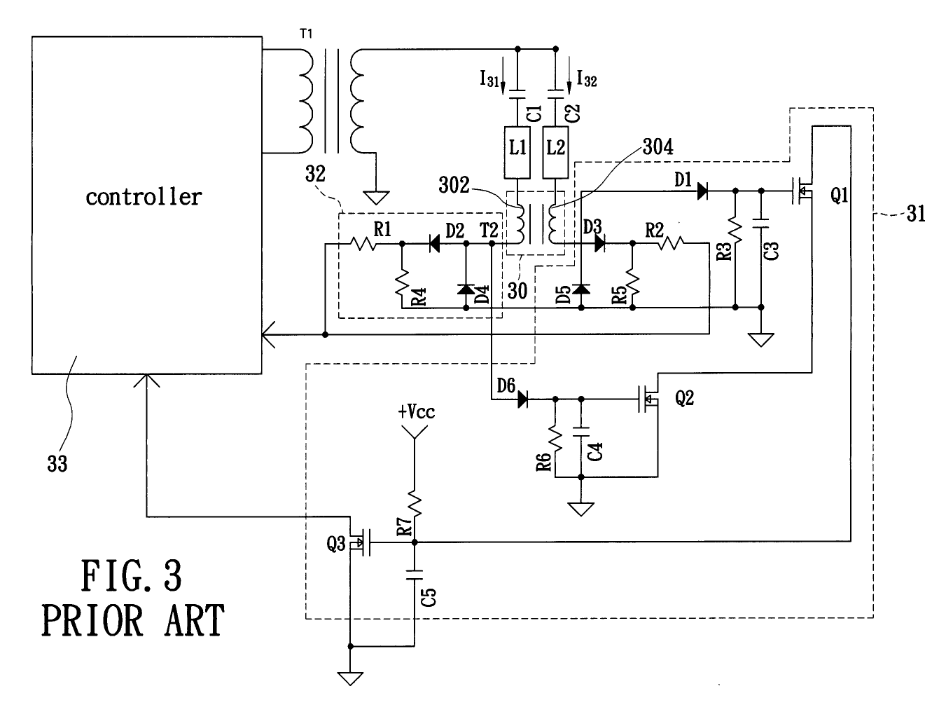

### DETAILED DESCRIPTION OF THE PREFERRED EMBODIMENTS

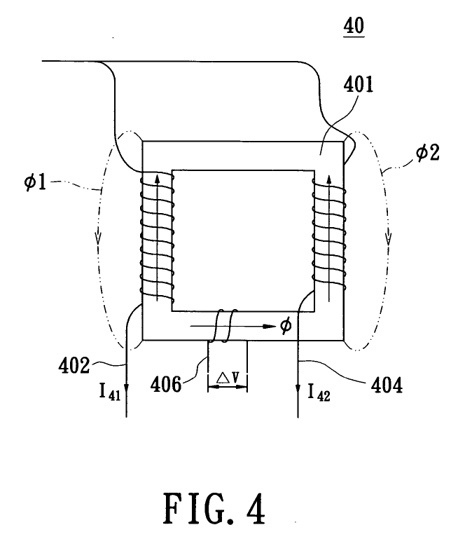

FIG. 4 shows a schematic diagram of an operating principle of a balance transformer with an auxiliary winding of the present invention. The balance transformer 40 with an auxiliary winding of the present invention connects to two CCFLs (not shown in the diagram) and has a magnetic core 401. The magnetic core 401 is used for a path of magnetic flux. The magnetic core 401 is wound with a first coil 402, a second coil 404 and an auxiliary coil 406. The winding direction of the first coil 402 and the second coil 404 are opposite to each other and make the balance transformer 40 acts as an adding pole transformer. When the currents 141, 142 passing through the coils 402, 404 are balanced, there is no reaction voltage at the two ends of the auxiliary coil 406. When the currents of coils are imbalanced, the auxiliary coil 406 produces a reaction voltage ΔV to act as a feedback signal for protecting the CCFLs. The magnetic core 401 is composed of two magnetic cores with an inverted U shape, two magnetic cores with an L shape, or a magnetic core with an inverted U shape, and a magnetic core with an I shape.

When two currents I₄₁, I₄₂ are the same, the currents that flow through the first coil 402 and the second coil 404 are also same. The magnetomotive force (MMF) of the first coil 402 produced by the current I₄₁ and the magnetomotive force (MMF) of the second coil 404 produced by the current I₄₂ are the same and cancel each other out. As such, there isn't magnetic flux in the magnetic core 401 of the balance transformer 40. At the same time, the leakage magnetic fluxes Φ1, Φ2 produced in the magnetic core 401 of the balance transformer 40 each form a loop via the outside air gap and the inductance effect produced by the loops can be ignored due to fact that the magnetic resistance in the air gap is high.

When the currents I₄₁ and I₄₂ are different, the MMF of the first coil 402 produced by the current I₄₁ and the MMF of the second coil 404 produced by the current 142 are also different. As such, the MMF in the magnetic core 401 of the balance transformer 40 is not equal and the difference of the MMF between the first coil 402 and the second coil 404 will produce a mass of magnetic flux Φ in the magnetic core 401 of the balance transformer 40. The magnetic flux Φ slices the auxiliary coil 406 and reacts to produce an amended voltage ΔV to act as a feedback signal for protecting the CCFLs.

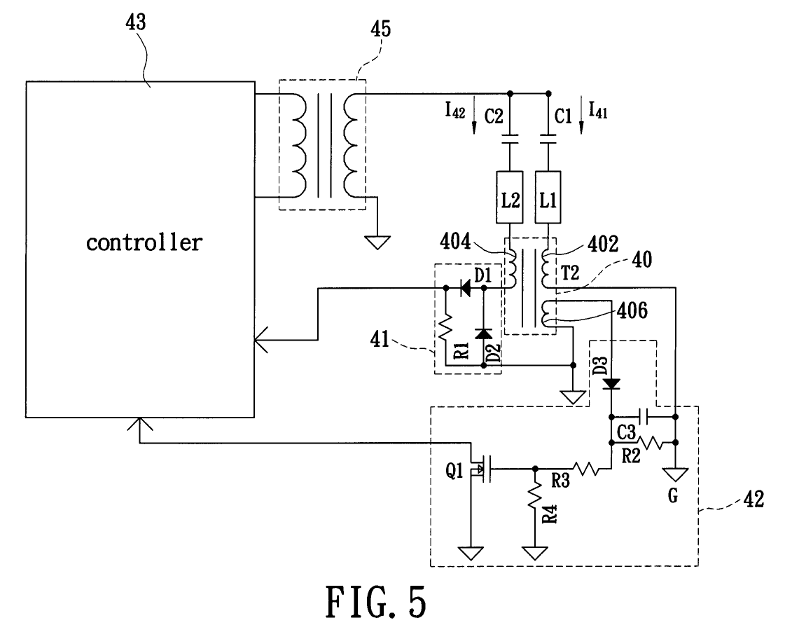

FIG. 5 is a schematic diagram of a circuit adopting the balance transformer with an auxiliary winding of the present invention to balance the currents of the CCFLs. One end of the first coil 402 of the balance transformer 40 connects to a CCFL L1 and the other end of the first coil 402 connects to a reference point G. One end of the second coil 404 of the balance transformer 40 connects to a CCFL L2 and the other end of the first coil 402 connects to a controller 43 via a voltage sensor 41. The auxiliary coil 406 of the balance transformer 40 connects to the controller 43 via a protection circuit 42. The turns of the first coil 402 and the second coil 404 are the same.

When the currents I₄₁, I₄₂ that flow through the CCFLs L1, L2 are different, the MMF of the first coil 402 produced by the current I₄₁ and the MMF of the second coil 404 produced by the current I₄₂ are also different. As such, the MMF in the magnetic core 401 of the balance transformer 40 is unequal and the difference between the MMF of the first coil 402 and the second coil 404 will produce a mass of magnetic flux Φ in the magnetic core 401 of the balance transformer 40. The magnetic flux Φ slices the auxiliary coil 406 and reacts to produce an amended voltage ΔV between the two ends of the auxiliary coil 406 to act as a feedback signal for protecting the CCFLs. The amended voltage ΔV is transmitted to the controller 43 via the protection circuit 42. After the controller 43 receives the feedback signal, it stops the operation to protect the CCFLs if there is an unbalanced current or conditions are abnormal.

The controller 43 outputs a high frequency periodic square wave and produces a high voltage via a boosted boost transformer 45. The high voltage, the capacitor C1, the capacitor C2, the CCFL L1, the CCFL L2 and the balance transformer 40 generate a harmonic oscillation. Because the inductor L1 and inductor L2 of the CCFLs oscillate harmonically in parallel, the difference between the capacitance and the resistance make the current of the CCFLs imbalanced. Therefore, in each circuit the coils of the balance transformer 40 must be wound around with coil having the same number of times to balance the current. Suppose the turns of the balance transformer 40 are N₁ and N₂; the currents flowing through the CCFLs are I₄₁ and I₄₂. According to Ampere's law, N₁I₄₁= [symbol] H̅dl and N₂I₄₂= [symbol] H̅dl. Because the balance transformer 40 is common iron core, N₁I₄₁=N₂I₄₂. If N₁=N₂, so I₄₁=I₄₂. The voltage at the coil with turns N₁ is V₁; the voltage at the coil with turns N₂ is V₂. We get,

$${V}_{1} = {L}_{1} \frac{ⅆ {i}_{41}}{ⅆ t} , \\ {i}_{41} = \frac{1}{{L}_{1}} \int {V}_{1} ⅆ t , \\ {V}_{2} = {L}_{2} \frac{ⅆ {i}_{42}}{ⅆ t} , \\ {i}_{42} = \frac{1}{{L}_{2}} \int {V}_{2} ⅆ t .$$

According to the principle of input being equal to output, the currents of CCFL, L1 and F2 are all the same. The voltage sensor 41 is composed of D1, D2 and R1 for sensing a sine wave voltage with a half period and transmitting it to a pulse width adjusting circuit (feedback circuit).

The auxiliary coil 406 of the balance transformer 40 connects to D3, R2 and C3 to form a peak sensor for detecting a DC voltage. The DC voltage is divided by R3 and R4 and connects to the gate of a transformer Q1. The voltage of the transformer Q1 has to set a voltage lower than a pre-determined value.

When one of the CCFLs L1, L2 is abnormal (burning down or lacking a connection), the balance relation of the coils of the balance transformer 40 is destroyed and the auxiliary coil 406 will react to produce a high voltage. At this moment, the gate-source voltage V_{GS} of the transformer Q1 is larger than the threshold voltage of the transformer Q1. Therefore, the drain-source D-S of the transformer Q1 will short out and stop the controller thereby protecting the CCFLs.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A balance transformer with an auxiliary winding comprising:
a magnetic core, for acting as a path for magnetic flux;
a first coil, wound onto the magnetic core;
a second coil, wound onto the magnetic core in the opposite direction of the first coil; and
an auxiliary coil, wound onto the magnetic core;
wherein, the balance transformer is a bi-pole transformer.

2. The balance transformer with an auxiliary winding of claim 1, wherein the turns of the first coil and the second coil are the same.

3. The balance transformer with an auxiliary winding of claim 1, wherein the magnetic core is composed of two magnetic cores with an inverted U shape.

4. The balance transformer with an auxiliary winding of claim 1, wherein the magnetic core is composed of two magnetic cores with an L shape.

5. The balance transformer with an auxiliary winding of claim 1, wherein the magnetic core is composed of one magnetic core with an inverted U shape and one magnetic core with an I shape.

6. A driving apparatus for CCFLs, connecting to two CCFLs, comprising:
a controller, providing currents to the two CCFLs via a boosted boost transformer;
a balance transformer, having a magnetic core, an auxiliary coil, a first coil and a second coil, a magnetic core, the magnetic core is a path for magnetic flux, the first coil winds onto the magnetic core and connects to one of the CCFLs at one end, the second coil winds onto the magnetic core in the opposite direction of the first coil and connects to another of the CCFLs at one end, the auxiliary coil winds onto the magnetic core;
a voltage sensor, connecting to another end of the second coil and the controller, for sensing the current flowing through the second coil;
a protection circuit, connecting to the auxiliary coil and the controller;
wherein, when currents flowing through the two CCFLs are balanced, there is no reacting voltage between the auxiliary coil, when the currents flowing through the CCFLs are different, the auxiliary coil reacts to produce an amended voltage, the amended voltage is transmitted to the controller via the protection circuit to act as a feedback signal for protecting the CCFLs.

7. The driving apparatus for CCFLs of claim 6, wherein another end of the first coil connects to a reference point.

8. The driving apparatus for CCFLs of claim 6, wherein the turns of the first coil and the second coil are the same.

9. The driving apparatus for CCFLs of claim 6, wherein the magnetic core is composed of two magnetic cores with an inverted U shape.

10. The driving apparatus for CCFLs of claim 6, wherein the magnetic core is composed of two magnetic cores with an L shape.

11. The driving apparatus for CCFLs of claim 6, wherein the magnetic core is composed of one magnetic core with an inverted U shape and one magnetic core with an I shape.
